(19) United States
(12) Patent Application Publication
(10) Pub. No.: US 2008/0127072 A1
(43) Pub. Date: May 29, 2008

(54) Method and system for extending evaluation for intermediate representation interpretation

(75) Inventors: Bernd J.W. Mathiske, Sunnyvale, CA (US); David M. Ungar, Mountain View, CA (US); Mario I. Wolczko, San Carlos, CA (US); Gregory M. Wright, Mountain View, CA (US); Matthew L. Seidl, Austin, TX (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/516,972

(22) Filed: Sep. 7, 2006

(51) Int. Cl. G06F 9/44; G06F 9/45

(52) U.S. Cl. 717/118; 717/146

(57) ABSTRACT

In general, in one aspect, the invention relates to a computer readable medium comprising executable instructions for verifying generation of an intermediate representation (IR). The generation of the IR is verified by generating the IR from source code and interpreting the IR to obtain an interpretation result. Interpreting the IR includes encountering a method call in the IR, locating an execution unit corresponding to the method call, executing the execution unit to obtain an execution result, replacing a portion of the IR with the execution result to obtain a reduced IR, and obtaining the interpretation result from the reduced IR. Finally, the interpretation result is compared to an expected result of the source code, wherein the generation of the IR is verified if the interpretation result equals the expected result.

### BACKGROUND

Computers are designed to execute computer programs written in a format understood by the computer, such as machine code. However, programmers typically do not write computer programs in machine code. Instead, programmers typically write computer programs using human readable programming languages (e.g., Java™ (Java™ is a trademark of Sun Microsystems, Inc.), C++, C#, etc.). The resulting computer program is then compiled to generate a computer program in a format understood by the computer.

The process of compilation is performed by a compiler. Compilers typically take the source code (e.g., computer program written in a human readable programming language) as input and generate an executable (e.g., a computer program in a format understood by the computer). Compilation is typically not a single step process from the source code to the executable. Rather, the compilation process translates the source code into an Intermediate Representation (IR). The IR may then be translated into the executable. Depending on the complexity of the compilation, there may be multiple intermediate representations between the source code and the executable. The following follow diagram illustrates this point.

Source code→IR→(IR)*→Executable, where * denotes ≧0

As discussed above, the source code (or previous IR) is translated to an IR and then subsequently translated from the IR to the executable (or subsequent IR). When writing a compiler that uses an IR(s), it is important to validate the translation from the source code (or previous IR) to the IR. Conventionally, the following method is used to validate the translation or, more specifically, the translation algorithm(s), used to obtain the IR.

Initially, the source code (or previous IR) is translated to obtain the IR. The source code (or previous IR) is associated with a known interpretation result. Said another way, the execution result of the executable corresponding to the source code is known. Returning to the method, the IR is subsequently input into an interpreter. The purpose of the interpreter is to execute the IR to obtain an interpretation result. Execution of the IR typically includes performing syntactic interpretation (e.g., β-reduction) to obtain one or more primitives (i.e., one of the basic building blocks of the IR). At this stage, the syntactic interpretation temporarily halts and meta-evaluation is invoked.

Meta-evaluation typically involves searching for the appropriate execution support for the primitive. Said another way, meta-evaluation involves determining whether the interpreter includes functionality to execute/evaluate the primitive and obtain a result. It is often the case that the interpreter does not include functionality to execute/evaluate the primitive. In such cases the interpreter may take one of the following courses of action. The interpreter, upon determining that it does not have functionality to evaluate the primitive fails, thereby halting the execution of the IR by the interpreter.

Alternatively, the interpreter may obtain a second IR, corresponding to the primitive. This alternative is typically taken when the primitive corresponds to a method call to a method referenced outside of the IR. Once the second IR corresponding to the primitive is obtained, the interpreter proceeds to execute the second IR to obtain the second execution result. If the interpreter successfully executes the second IR (i.e., interpreter includes functionality to execute/evaluate each encountered primitive during execution of the second IR), then the interpreter may return the second execution result to the interpreter such that the interpreter may continue executing the original IR. However, if the interpreter does not include functionality to execute/evaluate each encountered primitive in the second IR, then the interpreter may fail or obtain and execute/evaluate subsequent IRs corresponding to the encountered primitives that the interpreter does not include functionality to execute/evaluate.

Once the interpreter has generated the interpretation result (assuming that it has not failed during the interpretation of the IR), the interpretation result is compared to the expected result of the executed source code. If the results are the same, then the translation to the IR from the source code has been validated. Alternatively, if the interpretation result is not the same as the expected result, then an error likely exists in the translation algorithm used to generate the IR from the source code.

### SUMMARY

In general, in one aspect, the invention relates to a computer readable medium comprising executable instructions for verifying generation of an intermediate representation (IR). The generation of the IR is verified by generating the IR from source code and interpreting the IR to obtain an interpretation result. Interpreting the IR includes encountering a method call in the IR, locating an execution unit corresponding to the method call, executing the execution unit to obtain an execution result, replacing a portion of the IR with the execution result to obtain a reduced IR, and obtaining the interpretation result from the reduced IR. Finally, the interpretation result is compared to an expected result of the source code, wherein the generation of the IR is verified if the interpretation result equals the expected result.

In general, in one aspect, the invention relates to a computer readable medium comprising executable instructions for verifying the generation of an intermediate representation (IR). Verifying the IR includes generating the IR from source code and interpreting the IR to obtain an interpretation result. Interpreting the IR includes encountering a method call in the IR, locating an execution unit corresponding to the method call and determining whether a system executing the executable instructions includes functionality to execute the execution unit. If the system includes functionality to execute the execution unit, executing the execution unit to obtain an execution result. If the system does not include functionality to execute the execution unit: locating an equivalent execution unit corresponding to the execution unit, wherein the system is configured to execute the equivalent execution unit, executing the equivalent execution unit to obtain an equivalent execution result, and generating the execution result from the equivalent execution result. A portion of the IR is then replaced with the execution result to obtain a reduced IR, the interpretation result is obtained from the reduced IR, and the interpretation result is compared to an expected result of the source code, wherein the generation of the IR is verified if the interpretation result equals the expected result.

In general, the invention relates to a system comprising an interpreter. The interpreter is configured to obtain an intermediate representation (IR) and interpret the IR to obtain an interpretation result. Interpreting the IR includes encountering a method call in the IR, locating an execution unit corresponding to the method call, and determining whether a system executing the executable instructions includes functionality to execute the execution unit. If the system includes functionality to execute the execution unit, then executing the execution unit to obtain an execution result. If the system does not include functionality to execute the execution unit, then locating an equivalent execution unit corresponding to the execution unit, wherein the system is configured to execute the equivalent execution unit, executing the equivalent execution unit to obtain an equivalent execution result, and generating the execution result from the equivalent execution result. A portion of the IR is then replaced with the execution result to obtain a reduced IR, the interpretation result is obtained from the reduced IR, and comparing the interpretation result to an expected result of the source code, the generation of the IR is verified if the interpretation result equals the expected result.

Other aspects of the invention will be apparent from the following description and the appended claims.

### BRIEF DESCRIPTION OF DRAWINGS

FIG. 1 shows a flow chart in accordance with one embodiment of the invention.

FIG. 2 shows a system in accordance with one embodiment of the invention.

FIG. 3 shows a flow chart in accordance with one embodiment of the invention.

FIG. 4 shows a computer system in accordance with one embodiment of the invention.

### DETAILED DESCRIPTION

Specific embodiments of the invention will now be described in detail with reference to the accompanying figures. Like elements in the various figures are denoted by like reference numerals for consistency. Further, the use of “ST” in the drawings is equivalent to the use of “Step” in the detailed description below.

In the following detailed description of one or more embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention relate to a method and system for extending the functionality of an interpreter to execute intermediate representations. Further, by extending the functionality of the interpreter to execute the intermediate representations, the interpreter may be used to validate the translation of the source code to the intermediate representation.

In one embodiment of the invention, the intermediate representation (IR) corresponds to a representation of a computer program that is not directly executable by the computer (i.e., it is not machine code) but is executable by an interpreter. Further, in one embodiment of the invention, the IR may be obtained via translation from source code or from another IR.

In one embodiment of the invention, source code corresponds to any computer program (or portion thereof) that is not machine code. Examples of source code include human readable computer programs (or portions thereof), byte code, and intermediate representations derived (directly or indirectly) from byte code or from human readable computer programs.

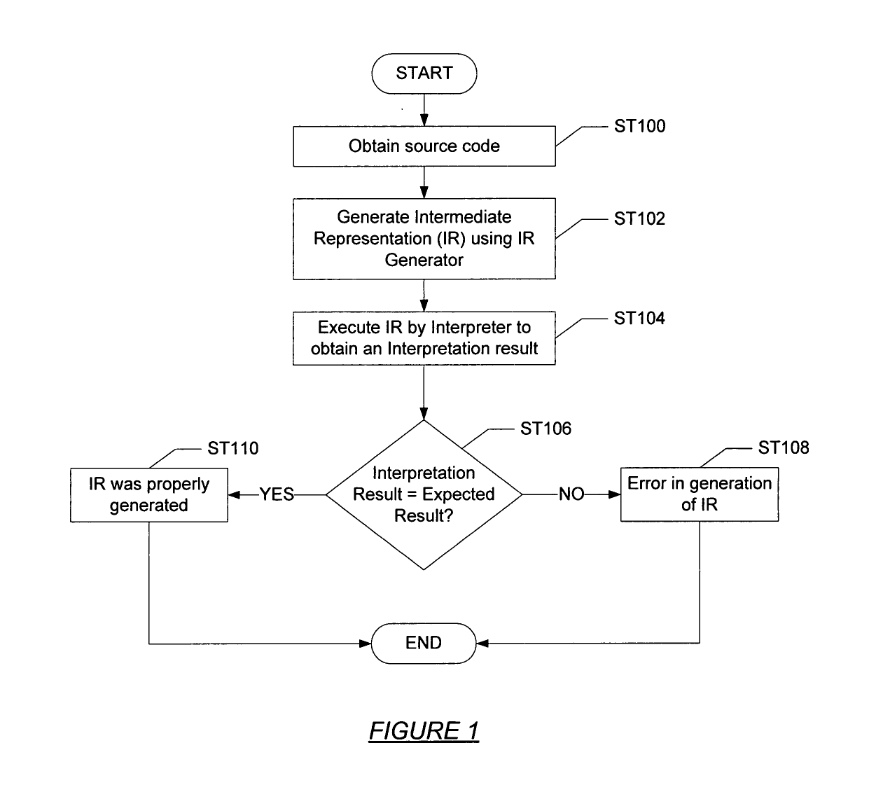

FIG. 1 shows a flow chart in accordance with one embodiment of the invention. More specifically, FIG. 1 shows the overall process of validating the translation of source code to the intermediate representation (IR). Initially, the source code is obtained (ST100). The source code is subsequently translated by an IR generator to obtain an IR (ST102). In one embodiment of the invention, the IR generator is included within a Java™ Virtual Machine (JVM) (Java™ is a trademark of Sun Microsystems, Inc.) and the source code corresponds to byte code.

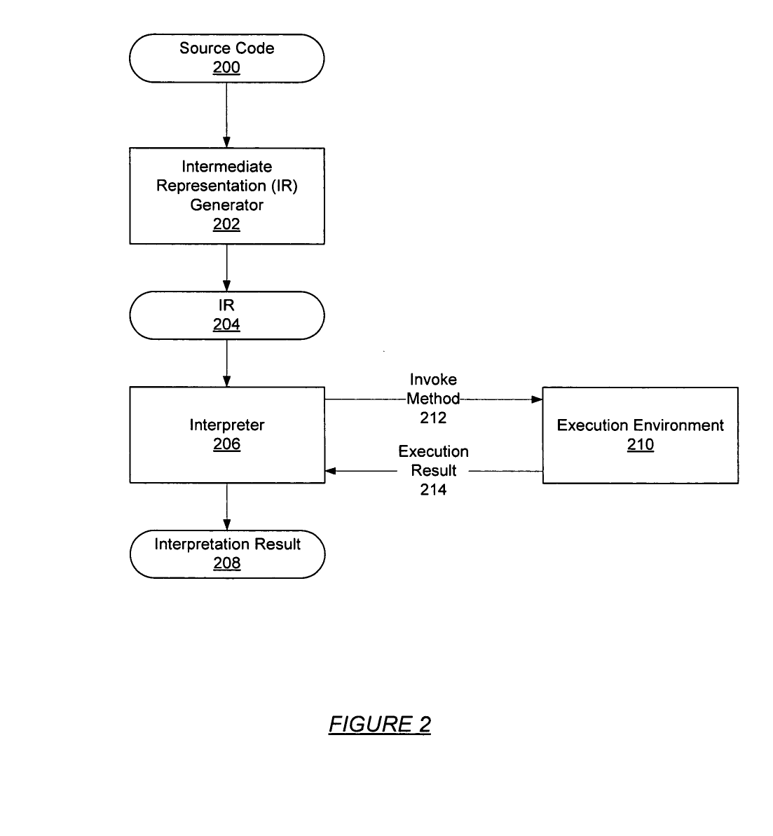

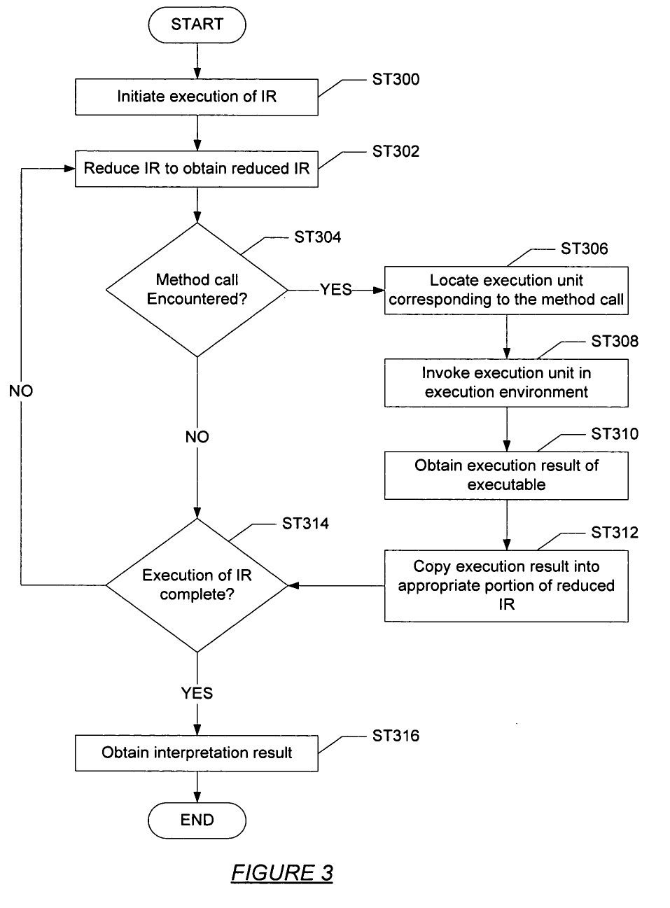

Continuing with the discussion of FIG. 1, the IR is subsequently executed by an interpreter to obtain an interpretation result (ST104). This step is described in FIGS. 2 and 3 below. At this stage a determination is made about whether the interpretation result is equal to the expected result (ST108). In one embodiment of the invention, the expected result corresponds to the result expected if the source code was executed. For example, if the source code included an addition operator and inputs of 3 and 4, then the expected result of the execution is 7.

Continuing with the discussion of FIG. 1, if the expected result is equal to the interpretation result, then the translation has been validated (i.e., the translation algorithm may have correctly translated the source code to the IR) (ST110). Alternatively, if the expected result is not equal to the interpretation result, then an error exists in the generation of the IR (or more specifically, in the translation algorithm used to obtain the IR) (ST108).

FIG. 2 shows a system in accordance with one embodiment of the invention. As shown in FIG. 2, the IR Generator (202) takes the source code (200) as input and generates an IR (204). In one embodiment of the invention, the IR Generator (202) corresponds to a program that includes one or more translation algorithms for translating the source code (200) to the IR (204).

As shown in FIG. 2, the Interpreter (206) takes the IR (204) as input and generates an interpretation result (208) as output. In one embodiment of the invention, the Interpreter (206) includes functionality to execute the IR (204). In one embodiment of the invention, functionality to execute the IR (204) corresponds to functionality to perform syntactic evaluation on the IR (204) to obtain one or more primitives. In one embodiment of the invention, syntactic evaluation may include β-reduction. Briefly, β-reduction (also known as function application) corresponds to substituting a variable in a λ expression (e.g., an expression within the IR) with a value. The result of the substitution results in the removal of the variable from the λ expression and the generation of a new simplified λ expression.

By repeating the β-reduction, the IR may be reduced from a complex set of expressions to one or more primitives. Primitives correspond to expressions in the IR (204) that cannot be simplified any further using syntactic evaluation. At this stage, the Interpreter (206) initiates meta-evaluation of the primitives.

In one embodiment of the invention, meta-evaluation of the primitives includes initially analyzing the built-in functions of the Interpreter (206) to determine whether the Interpreter (206) includes functionality to execute/evaluate the primitive. If the Interpreter (206) includes built-in functionality to execute/evaluate the primitive, then the Interpreter (206) proceeds to use the built-in functionality.

Alternatively, if the Interpreter (206) does not include built-in functionality to execute/evaluate the primitive, then the Interpreter (206) proceeds to determine whether the primitive corresponds to a method call (i.e., a call to a method, where the method is not defined within the IR (204) or the source code from which is was derived). If the primitive corresponds to a method call, then the Interpreter (206) proceeds to locate an execution unit corresponding to the method call.

In one embodiment of the invention, the execution unit corresponds to an executable version of the method call in the IR (204). In one embodiment of the invention, the execution unit may correspond to byte code, machine code, or any other type of executable code, which is capable of execution by any program or system other than the Interpreter (206).

Once the execution unit has been located, the Interpreter (206) invokes the method (212) in an execution environment (210). In one embodiment of the invention, the arguments to be used as input to the execution unit are obtained from the Interpreter (206).

In one embodiment of the invention, the execution environment (210) corresponds to a JVM. Alternatively, the execution environment (210) may correspond to any other system or program, except the Interpreter (206), configured to execute the execution unit. The result of executing the execution unit (i.e., the “execution result” (214)) is subsequently returned to the Interpreter (206).

In one embodiment of the invention, the execution result (214) is in a format that is understood by the Interpreter (206). Further, the execution result (214) may correspond to an expression that requires further syntactic and meta-evaluation. Once the Interpreter (206) has completed executing the IR (204), it generates an Interpretation Result (208).

In one embodiment of the invention, the Interpreter (206) uses reflection to locate and invoke the execution unit corresponding to the method call. In one embodiment of the invention, the Interpreter (206) uses the Java™ Reflection Application Programming Interface (API) to perform the reflection (Java™ is a trademark of Sun Microsystems, Inc.).

In one embodiment of the invention, the execution environment (210) may not include functionality to execute the execution unit. In such cases, the Interpreter (206) (or a related process) may include functionality to determine an equivalent execution unit, which the execution environment (210) can execute, that produces the same (or corresponding) output as execution of the execution unit would have produced. In such cases, the arguments for the equivalent execution unit may need to be modified prior to providing them as input to the equivalent execution unit. Similarly, the result of executing the equivalent execution unit (i.e., the equivalent execution results) may need to be modified to match the format (including argument name, type, value, etc.) of the expected evaluation result (214). Said another way, the equivalent execution results (214) may need to be modified such that they appear as though they were obtained via execution of the execution unit.

FIG. 3 shows a flow chart in accordance with one embodiment of the invention. More specifically, FIG. 3 describes the steps performed by the Interpreter when executing/evaluating the IR. Initially, the Interpreter initiates execution of the IR (ST300). During execution, the IR is reduced (using, for example, β-reduction) to obtain a reduced IR (ST302). The reduced IR is then evaluated to determine whether a method call, which requires execution/evaluation, has been encountered (ST304). Said another way, a determination is made about whether the reduced IR includes a method call and, if present, does the method call require evaluation at this stage of the execution.

If a method call requiring execution/evaluation is present, then the Interpreter proceeds to locate an execution unit (or equivalent execution unit) corresponding to the method call (ST306). Once the execution unit has been located, the Interpreter invokes the execution of the execution unit in the execution environment (ST308). The results of the execution (i.e., the execution results) are subsequently obtained (ST310). The execution results are subsequently copied into the appropriate portion of the reduced IR (ST312).

At this stage, a determination is made about whether execution of the IR is complete (i.e., does the result of ST312 correspond to the interpretation result) (ST314). If execution of the IR is complete, then the interpretation result is obtained (ST316). Alternatively, if the execution of the IR is not complete, then the method proceeds to ST302. In one embodiment of the invention, the interpretation result is then compared to the expected result to determine whether the translation to the IR from the source code is valid.

The following example illustrates various aspects of the invention. The example is not intended to limit the scope of the invention. In the following example, source code (see below) is translated to IR (see below). The IR is then subsequently interpreted to determine whether the translation is correct.

Source Code

```
private boolean perform_instanceof(final Object x) {
        return x instanceof Integer;
    }
```

The source code corresponds to a Boolean function which returns True, if the argument of the function is an integer.

The following is the IR generated when perform_instanceof (new Integer(345)) is called. The expected result is True.

IR

```
{proc[pR0-1 pR1-2 cc-3 ce-4] .
|  {block#0[cc-5 pR1-6 ce-7] .
|  |  {proc[sR0-8] .
|  |  |  <[com.sun.max.jvm.compile.snippet.ResolutionSnippet
$Snippet_resolveType]>:_resolveType
|  |  |  (<ClassConstant: Ljava/lang/Integer;> {cont[tR-9] .
|  |  |  |  <[com.sun.max.jvm.compile.snippet.-
InstanceSnippet $Snippet_instanceOf]>:_instanceOf
|  |  |  |  (tR-9 sR0-8 {cont[tI-10] .
|  |  |  |  |  {proc[sI0-11] .
|  |  |  |  |  |  cc-5(sI0-11)
|  |  |  |  |  }(tI-10)
|  |  |  |  } ce-7)
|  |  |  } ce-7)
|  |  }(pR1-6)
|  }(cc-3 pR1-2 ce-4)
}(test_instanceof
  (test.com.sun.max.jvm.compile.mir.generate.TranslatorTest_misc)
  345 cc ce)
```

An Interpreter is then used to execute/evaluate the IR. Initially, the IR is reduced, using β-reduction, to obtain Reduced IR 1.

Reduced IR 1

block#0[cc-5 pR1-6 ce-7] .
| {proc[sR0-8] .
| | <[com.sun.max.jvm.compile.snippet.ResolutionSnippet
$Snippet_resolveType]>:_resolveType
| | (<ClassConstant: Ljava/lang/Integer;> {proc[tR-9] .
| | | <[com.sun.max.jvm.compile.snippet.InstanceSnippet
$Snippet_instanceOf]>:_instanceOf
| | | (tR-9 sR0-8 {proc[tI-10] .
| | | | {proc[sI0-11] .
| | | | | cc-5(sI0-11)
| | | | }(tI-10)
| | | } ce-7)
| | } ce-7)
| }(pR1-6)
}(cc 345 ce)

Reduced IR 1 is then reduced, using β-reduction, to obtain Reduced IR 2.

Reduced IR 2

{proc[cc-5 pR1-6 ce-7] .
| {proc[sR0-8] .
| | <[com.sun.max.jvm.compile.snippet.ResolutionSnippet
$Snippet_resolveType]>:_resolveType
| | (<ClassConstant: Ljava/lang/Integer;> {proc[tR-9] .
| | | <[com.sun.max.jvm.compile.snippet.InstanceSnippet
$Snippet_instanceOf]>:_instanceOf
| | | (tR-9 sR0-8 {proc[tI-10] .
| | | | {proc[sI0-11] .
| | | | | cc-5(sI0-11)
| | | | }(tI-10)
| | | } ce-7)
| | } ce-7)
| }(pR1-6)
}(cc 345 ce)

Reduced IR 2 is then reduced, using β-reduction, to obtain Reduced IR 3.

Reduced IR 3

{proc[sR0-4] .
| <[com.sun.max.jvm.compile.snippet.ResolutionSnippet
$Snippet_resolveType]>:_resolveType
| (<ClassConstant: Ljava/lang/Integer;> {proc[tR-5] .
| | <[com.sun.max.jvm.compile.snippet.InstanceSnippet
$Snippet_instanceof]>:_instanceOf
| | (tR-5 sR0-4 {proc[tI-6] .
| | | {proc[sI0-7] .
| | | | cc(sI0-7)
| | | }(tI-6)
| | } ce)
| } ce)
}(345)

Reduced IR 3 is then reduced, using β-reduction, to obtain Reduced IR 4.

Reduced IR 4

<[com.sun.max.jvm.compile.snippet.ResolutionSnippet
$Snippet_resolveType]>:_resolveType
(<ClassConstant: Ljava/lang/Integer;> {proc[tR-2] .
| <[com.sun.max.jvm.compile.snippet.InstanceSnippet
$Snippet_instanceOf]>:_instanceOf
| (tR-2 345 {proc[tI-3] .
| | {proc[sI0-4] .
| | | cc(sI0-4)
| | }(tI-3)
| } ce)
} ce)

At this stage, the Interpreter encounters a primitive corresponding to a method call (i.e., call_resolveType). The Interpreter, using reflection, locates the corresponding execution unit (in this case, byte code) corresponding to the call_resolveType method. Once located, the execution unit corresponding to the call_resolveType method is invoked with the argument “Ljava.Lang/Integer;” The execution result of executing the aforementioned execution unit is java.lang.Integer. The execution result is then pasted into the appropriate portion of Reduced IR 4, to produce Reduced IR 5.

Reduced IR 5

{proc[tR-2] .
| <[com.sun.max.jvm.compile.snippet.InstanceSnippet
$Snippet_instanceOf]>:_instanceOf
| (tR-2 345 {proc[tI-3] .
| | {proc[sI0-4] .
| | | cc(sI0-4)
| | }(tI-3)
| } ce)
}(java.lang.Integer)

Reduced IR 5 is then reduced, using β-reduction, to obtain Reduced IR 6.

Reduced IR 6

<[com.sun.max.jvm.compile.snippet.-
InstanceSnippet$Snippet_instanceOf] >:_instanceOf
(java.lang.Integer 345 {proc[tI-2] .
| {proc[sI0-3] .
| | cc(sI0-3)
| }(tI-2)
} ce)

At this stage, the Interpreter encounters a primitive corresponding to a method call (i.e., call_instanceOf). The Interpreter, using reflection, locates the corresponding execution unit (in this case, byte code) corresponding to the call_instanceOf method. Once located, the execution unit corresponding to the call_instanceOf method is invoked with the argument “java.lang.Integer, 345.” The execution result of executing the aforementioned execution unit is “true.” The execution result is then pasted in to the appropriate portion of Reduced IR 6, to produced Reduced IR 7.

Reduced IR 7

{proc[tI-2] .
| {proc[sI0-3] .
| | cc(sI0-3)
| }(tI-2)
}(true)

Reduced IR 7 is then reduced, using β-reduction, to obtain Reduced IR 8.

Reduced IR 8

{proc[sI0-2] .
| cc(sI0-2)
}(true)

Reduced IR 8 is then reduced, using β-reduction, to obtain Reduced IR 9.

Reduced IR 9
cc(true)

At this stage, the Reduced IR 9 generates an Interpretation result of True. The interpretation result of True is then compared to the expected result of the source code, namely, True. Because the expected result and the interpretation result are equal, the translation of the source code to the IR is valid.

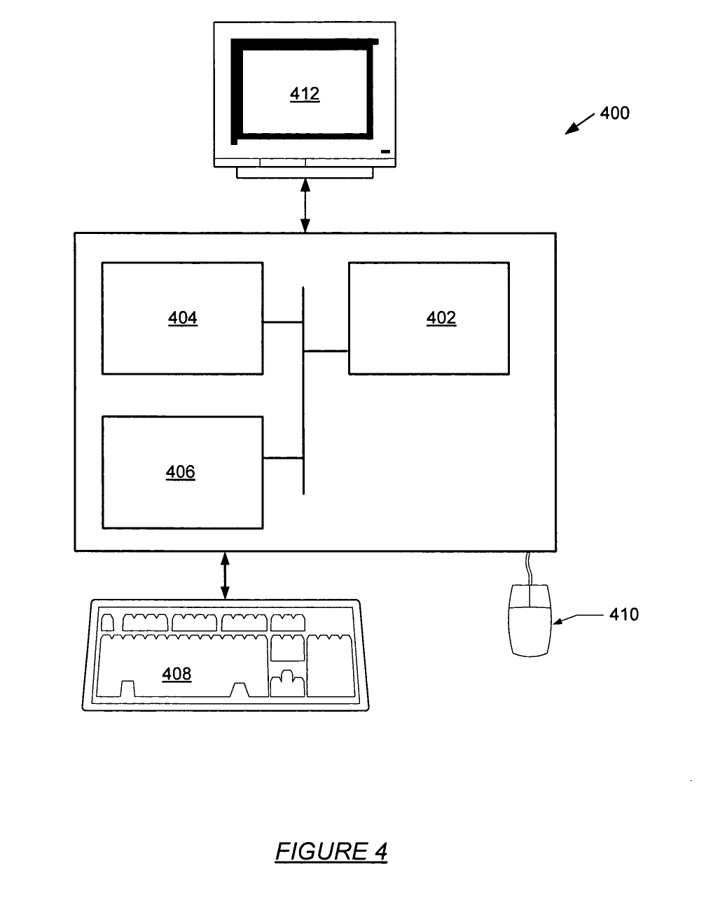

The invention may be implemented on virtually any type of computer regardless of the platform being used. For example, as shown in FIG. 4 a networked computer system (400) includes a processor (402), associated memory (404), a storage device (406), and numerous other elements and functionalities typical of today's computers (not shown). The networked computer system (400) may also include input means, such as a keyboard (408) and a mouse (410), and output means, such as a monitor (412). The networked computer system (400) is connected to a local area network (LAN) or a wide area network (e.g., the Internet) (not shown) via a network interface connection (not shown). Those skilled in the art will appreciate that these input and output means may take other forms. Further, those skilled in the art will appreciate that one or more elements of the aforementioned computer (400) may be located at a remote location and connected to the other elements over a network. Further, the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory.

Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer readable medium comprising executable instructions for verifying generation of an intermediate representation (IR) by:
generating the IR from source code;
interpreting the IR to obtain an interpretation result, wherein interpreting the IR comprises:
encountering a method call in the IR,
locating an execution unit corresponding to the method call,
executing the execution unit to obtain an execution result,
replacing a portion of the IR with the execution result to obtain a reduced IR, and
obtaining the interpretation result from the reduced IR; and
comparing the interpretation result to an expected result of the source code, wherein the generation of the IR is verified if the interpretation result equals the expected result.

2. The computer readable medium of claim 1, wherein the source code corresponds to byte code.

3. The computer readable medium of claim 1, wherein the execution unit is byte code.

4. The computer readable medium of claim 3, wherein executing the execution unit corresponds to executing the byte code on a virtual machine.

5. The computer readable medium of claim 4, wherein the IR is generated using a first IR generator and the virtual machine comprises a second IR generator, wherein the second IR generator is used by the virtual machine to convert the byte code into executable machine code.

6. The computer readable medium of claim 1, wherein locating the execution unit corresponding to the method call comprises using reflection.

7. The computer readable medium of claim 1, wherein the method call is encountered during reduction of the IR.

8. The computer readable medium of claim 1, wherein the interpretation result is obtained directly from the reduced IR.

9. A computer readable medium comprising executable instructions for verifying the generation of an intermediate representation (IR) by:
generating the IR from source code;
interpreting the IR to obtain an interpretation result, wherein interpreting the IR comprises:
encountering a method call in the IR,
locating an execution unit corresponding to the method call,
determining whether a system executing the executable instructions includes functionality to execute the execution unit;
if the system includes functionality to execute the execution unit:
executing the execution unit to obtain an execution result;
if the system does not include functionality to execute the execution unit:
locating an equivalent execution unit corresponding to the execution unit, wherein the system is configured to execute the equivalent execution unit,
executing the equivalent execution unit to obtain an equivalent execution result, and
generating the execution result from the equivalent execution result, and
replacing a portion of the IR with the execution result to obtain a reduced IR, and
obtain the interpretation result from the reduced IR; and
comparing the interpretation result to an expected result of the source code, wherein the generation of the IR is verified if the interpretation result equals the expected result.

10. The computer readable medium of claim 9, wherein the source code corresponds to byte code.

11. The computer readable medium of claim 9, wherein the execution unit is Java™ byte code.

12. The computer readable medium of claim 11, wherein the executing the execution unit corresponds to executing the byte code on a Java™ virtual machine.

13. The computer readable medium of claim 9, wherein locating the execution unit corresponding to the method call comprises using a Java™ reflection Application Programming Interface (API).

14. The computer readable medium of claim 9, wherein the method call is a Java™ method call.

15. A system, comprising:
an interpreter configured to:
obtain an intermediate representation (IR);
interpret the IR to obtain an interpretation result, wherein interpreting the IR comprises:
encountering a method call in the IR,
locating an execution unit corresponding to the method call,
determining whether a system executing the executable instructions includes functionality to execute the execution unit;
if the system includes functionality to execute the execution unit:
executing the execution unit to obtain an execution result;
if the system does not include functionality to execute the execution unit:
locating an equivalent execution unit corresponding to the execution unit, wherein the system is configured to execute the equivalent execution unit,
executing the equivalent execution unit to obtain an equivalent execution result, and
generating the execution result from the equivalent execution result, and
replacing a portion of the IR with the execution result to obtain a reduced IR, and
obtain the interpretation result from the reduced IR; and
comparing the interpretation result to an expected result of the source code, wherein the generation of the IR is verified if the interpretation result equals the expected result.

16. The computer readable medium of claim 14, wherein the source code corresponds to byte code.

17. The computer readable medium of claim 14, wherein the execution unit is byte code.

18. The computer readable medium of claim 17, wherein executing the execution unit corresponds to executing the byte code on a virtual machine.

19. The computer readable medium of claim 14, wherein locating the execution unit corresponding to the method call comprises using reflection.

20. The computer readable medium of claim 14, wherein the method call is encountered during reduction of IR.
